(19) United States
(12) Patent Application Publication
(10) Pub. No.: US 2025/0340687 A1
(43) Pub. Date: Nov. 6, 2025

(54) BIMODAL MOLECULAR WEIGHT LOW ETHYLENE CONTENT PROPYLENE-BASED RANDOM COPOLYMER COMPOSITIONS AND METHODS

(71) Applicant: EXXONMOBIL CHEMICAL PATENTS INC., Baytown, TX (US)

(72) Inventors: Xuejia YAN, Manvel, TX (US); Ranadip GANGULY, Houston, TX (US); Syamal TALLURY, Houston, TX (US); Xiaodan ZHANG, Houston, TX (US); Caitlin A. SPOFFORD, Houston, TX (US); George J. PEHLERT, Houston, TX (US)

(73) Assignee: EXXONMOBIL CHEMICAL PATENTS INC., Baytown, TX (US)

(21) Appl. No.: 19/115,210

(22) PCT Filed: Oct. 3, 2023
(86) PCT No.: PCT/US2023/034392

§ 371 Date: Mar. 25, 2025

Related U.S. Application Data
(60) Provisional application No. 63/379,580, filed on Oct. 14, 2022.

(51) Int. Cl. C08F 210/06

(52) U.S. Cl. CPC C08F 210/06; C08F 2800/20

(57) ABSTRACT

Compositions, methods, and molded articles including a bimodal molecular weight ethylene/propylene random copolymer comprising a high molecular weight component having a melt flow rate at 230° C. of from about 0.02 g/10 min to about 0.5 g/10 min and a low molecular weight component having a melt flow rate at 230° C. of from about 1 g/10 min to about 10 g/10 min, and an ethylene content of from about 0.40 wt. % to about 0.60 wt. %.

### FIELD OF THE INVENTION

The present disclosure relates to bimodal molecular weight low ethylene content propylene-based random copolymer compositions and methods related thereto, and more particularly, to bimodal molecular weight low ethylene content propylene-based random copolymer compositions having improved strength and toughness (stiffness) and clarity, and methods related thereto.

### BACKGROUND OF THE INVENTION

Polypropylene is one of the most widely used thermoplastics for a variety of applications because of its superior physical properties. In particular, polypropylene exhibits excellent properties as compared with other polyolefins in terms of chemical resistance to organic solvents, tensile strength, and case of processability, for example. Conventional uses of polypropylene include packaging products (molded articles), such as food containers, beverage containers, storage containers, plastic jars, lids and covers related thereto, among others. These packaging products are often desirably rigid, such that they can be formed into different shapes suited for a specific application and maintain such shape. Further, such packaging products often desirably feature high clarity (low-haze), making it easy to view the packaged item.

However, polypropylene specimens can be quite brittle and can thus exhibit undesirable mechanical performance, particularly for use in packaging products. As such, polypropylene is generally compounded with elastomeric polymers, such as ethylene, to form random copolymers having improved impact strength and toughness. Ethylene content in polypropylene copolymers is used for product packaging because of such impact strength and toughness, as well as other advantages, including favorable heat sealing characteristics. However, unwanted side effects can result as ethylene content increases, such as a high amount of extractables leading to processing difficulties and restrictions in food and medical packaging product applications. Certain of these processing difficulties, such as an increased propensity of oligomer/additive migration can cause visible signs of blooming that result in a negative impact on clarity.

Accordingly, there is a need for a low ethylene content ethylene/propylene copolymer that has favorable strength and toughness, as well as clarity, for use in rigid packaging products.

### SUMMARY

The present disclosure relates to bimodal molecular weight low ethylene content propylene-based random copolymer compositions and methods related thereto, and more particularly, to bimodal molecular weight low ethylene content propylene-based random copolymer compositions having improved strength and toughness and clarity, and methods related thereto.

In one or more aspects, the present disclosure provides a composition including a bimodal molecular weight ethylene/propylene random copolymer. The bimodal molecular weight ethylene/propylene random copolymer includes a high molecular weight component having a melt flow rate at 230° C. of from about 0.02 g/10 min to about 0.5 g/10 min and a low molecular weight component having a melt flow rate at 230° C. of from about 1 g/10 min to about 10 g/10 min, and an ethylene content of from about 0.40 wt. % to about 0.60 wt. %.

In one or more aspects, the present disclosure provides a method of polymerizing ethylene and propylene monomers to produce a bimodal molecular weight ethylene/propylene random copolymer. The bimodal molecular weight ethylene/propylene random copolymer includes a high molecular weight component having a melt flow rate at 230° C. of from about 0.02 g/10 min to about 0.5 g/10 min and a low molecular weight component having a melt flow rate at 230° C. of from about 1 g/10 min to about 10 g/10 min, and an ethylene content of from about 0.40 wt. % to about 0.60 wt. %.

In one or more aspects, the present disclosure provides a molded article including a bimodal molecular weight ethylene/propylene random copolymer. The bimodal molecular weight ethylene/propylene random copolymer includes a high molecular weight component having a melt flow rate at 230° C. of from about 0.02 g/10 min to about 0.5 g/10 min and a low molecular weight component having a melt flow rate at 230° C. of from about 1 g/10 min to about 10 g/10 min, and an ethylene content of from about 0.40 wt. % to about 0.60 wt. %.

### DETAILED DESCRIPTION OF THE INVENTION

The present disclosure relates to bimodal molecular weight low ethylene content propylene-based random copolymer compositions and methods related thereto, and more particularly, to bimodal molecular weight low ethylene content propylene-based random copolymer compositions having improved strength and toughness and clarity, and methods related thereto.

The propylene-based random copolymer compositions described herein comprise a polypropylene random copolymer with low ethylene content and a high molecular weight polypropylene homopolymer. Such bimodal molecular weight propylene-based random copolymer compositions comprise a high degree of strength/toughness (stiffness) and clarity.

As discussed above, ethylene/propylene random copolymers can be effectively used for the manufacture of packaging products, particularly rigid packaging products, but may suffer from a tradeoff between strength/toughness and clarity. The present disclosure alleviates the foregoing difficulties and provides related advantages as well. In particular, the present disclosure provides an improvement in strength/toughness and clarity of ethylene/propylene random copolymers by capitalizing on a bimodal molecular weight distribution thereof.

Illustrative aspects of the present disclosure include ethylene/propylene random copolymers, methods of producing the same, and packaging products produced therefrom.

### Definitions and Test Methods

All numerical values within the detailed description and the claims herein are modified by “about” or “approximately” with respect to the indicated value, and take into account experimental error and variations that would be expected by a person having ordinary skill in the art. Unless otherwise indicated, ambient temperature (room temperature or “RT”) is about 25° C.

As used in the present disclosure and claims, the singular forms “a,” “an,” and “the” include plural forms unless the context clearly dictates otherwise.

The term “and/or” as used in a phrase such as “A and/or B” herein is intended to include “A and B.” “A or B.” “A.” and “B.”

For the purposes of the present disclosure and the claims thereto, the following definitions shall be used.

As used herein, a “copolymer,” and grammatical variants thereof, is comprised of polymerized co-monomers of propylene and ethylene. The copolymers described herein are “random copolymers,” in which ethylene monomer residues are randomly located within a polypropylene polymer. As used herein, the term “co-polypropylene polymer” will refer to a random copolymer of propylene and ethylene.

As used herein, the term “melt flow rate” or “MFR,” and grammatical variants thereof, is the number of grams extruded in 10 minutes under the action of a standard load and is an inverse measure of viscosity. A high MFR implies low viscosity and low MFR implies high viscosity. In addition, the copolymers described herein are shear thinning, which means that their resistance to flow decreases as the shear rate increases. This is due to molecular alignments in the direction of flow and disentanglements. As provided herein, MFR (12, 230° C., 2.16 kg) is determined according to ASTM D-1238-E(20) and is measured in grams per minute (g/min).

The term “melt temperature” or “Tm,” and grammatical variants thereof, refers to a copolymer melt temperature at an extruder die, which has units of ° C. unless otherwise specified.

The term “crystallization temperature” or “Tc,” and grammatical variants thereof, refers to the temperature at which transition from an amorphous-liquid state of a copolymer melt to a crystalline state occurs, and has units of ° C., unless otherwise specified.

As used herein, the term “plaque haze,” and grammatical variants thereof, refers to the scattering of light as it passes through the co-polypropylene polymers of the present disclosure. The plaque haze is determined according to ASTM D1003B-21 based on 1 mm plaque thickness.

The term “flexural modulus,” and grammatical variants thereof, refers to the tendency of a material to bend in terms of a ratio of stress to strain and is determined according ASTM D790A-17. Flexural modulus has units of kilo-pounds per-square-inch (kpsi).

The term “tensile strength,” and grammatical variants thereof, refers to the plastic strength specifications of unreinforced and reinforced polymers. The test method uses standard dogbone-shaped specimens under 14 millimeters of thickness and is performed according to ASTM D638-22. Tensile strength has units of pounds per-square-inch (psi).

As used herein, the term “Notched Izod,” and grammatical variants thereof, refers to a measure of impact resistance from a swinging pendulum; it is a degree of kinetic energy needed to initiate a fracture in a material and continue the fracture until the material is broken. Notched Izod is determined according to ASTM D256A-10 and measured in units of foot pound per inch (ft-lb/inch).

As used herein, “Mₙ” is number average molecular weight and “M_{w}” is weight average molecular weight. Unless otherwise noted, all molecular weight units (e.g., M_{w} and Mₙ), including molecular weight data, are in the unit of kilograms per mol (kg/mol). Molecular weight was tested according to the GPC-4D method.

As used herein, the term “molecular weight distribution” or “MWD,” and grammatical variants thereof, is equivalent to the expression M_{w}/Mₙ and is also referred to as polydispersity index (PDI). The expression M_{w}/Mₙ is the ratio of the M_{w} to the Mₙ. The M_{w} is given by:

$${M}_{w} = \frac{{\sum }_{i} {n}_{i} {M}_{i}^{2}}{{\sum }_{i} {n}_{i} {M}_{i}}$$

The Mₙ is given by:

$${M}_{n} = \frac{{\sum }_{i} {n}_{i} {M}_{i}}{{\sum }_{i} {n}_{i}}$$

where nᵢ in the foregoing equations is the number fraction of molecules of molecular weight Mᵢ.

The term “bimodal molecular weight distribution” or “bimodal MWD,” as used herein with reference to a co-polypropylene polymer, and grammatical variants thereof, refers to the co-polypropylene polymer having components of at least two different molecular weights, including a relatively higher molecular weight (HMW) component and a relatively lower molecular weight (LMW) component. The bimodal co-polypropylene polymers of the present disclosure are physically blended, such as by extrusion compounding.

As used herein, the term “ethylene percentage” or “C2%,” and grammatical variants thereof, refers to the percentage of ethylene included in a co-polypropylene polymer.

As used herein, the terms “slurry polymerization,” “slurry,” and “slurry polymerization reactor,” and grammatical variants thereof, each refer to a process where an olefin (e.g., propylene) is partly dissolved or not dissolved in the polymerization medium. During slurry polymerization, catalyst components, solvent, a-olefins, and hydrogen can be passed under pressure to one or more slurry polymerization reactors. Typically, catalyst components are fed to the slurry polymerization reactor as a mixture in aliphatic hydrocarbon solvent, in oil, a mixture thereof, or as a dry powder.

The term “extruder,” and grammatical variants thereof, as used herein, includes any machine suitable for polyolefin extrusion. For example, the term includes machines that can extrude polyolefin in the form of powder or pellets, sheets, fibers, or other shapes and/or profiles, without limitation. Generally, an extruder operates by feeding polymeric material through the feed throat which comes into contact with one or more rotating screws. The rotating screw(s) force the polyolefin forward into one or more heated barrels. In some processes, a heating profile can be set for the barrel in which one or more (e.g., three or more) independent proportional-integral-derivative controller (PID)-controlled heater zones can gradually increase the temperature of the barrel. The extruder may be a single-screw or twin-screw extruder.

### Co-polypropylene Random Copolymer, Methods, and Systems

Compositions and methods for producing co-polypropylene polymers include the preparation of co-polypropylene polymers compositions having low ethylene content and bimodal molecular weights demonstrating enhanced flexural modulus values (stiffness) and tensile strength, as well as enhanced plaque haze (clarity).

Compositions and methods disclosed herein include the preparation of co- polypropylene polymer compositions by polymerization having bimodal molecular weight and enhanced strength and toughness and clarity. Co-polypropylene polymer compositions disclosed herein may include a mixture of a polypropylene polymer and a second polyethylene polymer in a low concentration, as described herein.

The co-polypropylene polymers of the present disclosure may have an ethylene content of less than about 0.60 wt. %, such as less than about 0.50 wt. %, or in the range of about 0.40 wt. % to about 0.60 wt. %, encompassing any value and subset therebetween.

The co-polypropylene polymers of the present disclosure may have a flexural modulus of greater than about 240 kpsi, such as in the range of about 240 kpsi to about 280 kpsi, encompassing any value and subset therebetween.

The co-polypropylene polymers of the present disclosure may have a tensile strength in the range of greater than about 5200 psi, such as greater than about 5300 psi, or in the range of about 5200 psi to about 5700 psi, encompassing any value and subset therebetween.

The co-polypropylene polymers of the present disclosure may have a plaque haze of less than about 35%, such as less than about 30%, or in the range of about 20% to about 35%, based on a 1 mm thickness sample, encompassing any value and subset therebetween.

The co-polypropylene polymers of the present disclosure may have an MFR at 230° C. in the range of from about 1 g/10 min to about 10 g/10 min, such as about 1.5 g/10 min to about 4 g/10 min, encompassing any value and subset therebetween.

The co-polypropylene polymers of the present disclosure may have a melt temperature (Tm) in the range of about 150° C. to about 170° C., such as about 155° C. to about 165° C., encompassing any value and subset therebetween.

The co-polypropylene polymers of the present disclosure may have a crystallinity temperature (Tc) of from about 100° C. to about 130° C., such as about 120° C. to about 125° C., encompassing any value and subset therebetween.

The co-polypropylene polymers of the present disclosure described herein molecular weight (Mw) of from about 300 kg/mol to about 700 kg/mol, such as about 400 kg/mol to about 600 kg/mol, encompassing any value and subset therebetween.

The co-polypropylene polymers of the present disclosure may have an MWD of from about 5 to about 20, such as about 5 to about 16, or about 5 to about 14, encompassing any value and subset therebetween.

In one or more aspects, the co-polypropylene polymers of the present disclosure may include at least an HMW component having an MFR at 230° C. in the range of about 0.02 g/10 min to about 0.5 g/10 min and an LMW component having an MFR at 230° C. in the range of about 1 g/10 min to about 10 g/10 min, encompassing any value and subset therebetween. In one or more aspects, the HMW component may include a polypropylene homopolymer and the LMW component may include a polypropylene/polyethylene random co-polymer having a low concentration of ethylene, as described herein. The amount of HMW component(s) may be in the range of about 15 wt. % to about 2 wt. % of the LMW component(s), encompassing any value and subset therebetween.

The co-polypropylene polymers of the present disclosure may have a Notched Izod impact value at 23° C. of from about 0.5 ft-lb/inch to about 1 ft-lb/inch, such as about 0.7 ft-lb/inch to about 0.9 J/m, encompassing any value and subset therebetween.

Methods disclosed herein may include single-stage or multi-stage polymerization processes having a first stage in which one or more polypropylene polymerization reactions produce a first and/or second polypropylene and a second stage that produces a second polyethylene polymer. The two polymers may be co-extruded to form the co-polypropylene polymers of the present disclosure. In one or more aspects, the co-extrusion compounding may be achieved using a screw extruder, such as a 30 mm Werner & Pfleiderer twin screw extruder (New Jersey, USA).

Processes described herein may be used in combination with other techniques to tune strength and toughness and clarity, including post-reactor modification by crosslinking or blending with other additives, such as antioxidants.

A method for preparing the co-polypropylene polymer compositions of the present disclosure may include polymerizing propylene and ethylene with a non-phthalate Ziegler-Natta catalyst system to form the ethylene/propylene random co-polymer composition, and extruding the ethylene/propylene random co-polymer composition to form the co-polypropylene polymer composition.

Various Ziegler-Natta pro-catalysts may be used in the non-phthalate catalyst system, although other catalyst systems for polymerizing propylene and ethylene may be used, without departing from the scope of the present disclosure. For example, the Ziegler-Natta procatalyst composition may include a transition metal compound and a Group 2 metal compound. The transition metal compound may include a solid complex derived from a transition metal compound, such as, titanium-, zirconium-, chromium- or vanadium-hydrocarbyloxides, hydrocarbyls, halides, or mixtures thereof. In one or more aspects, the Ziegler-Natta procatalyst composition comprises a titanium transition metal, a magnesium Group 2 metal, and a chloride halogen.

The polymerization process comprises polymerizing ethylene (in low concentration) and propylene in the presence of the non-phthalate catalyst system under reaction conditions sufficient to form the co-polypropylene polymer compositions of the present disclosure.

Any kind of polymerization process suitable for preparing a polyolefin can be used with the catalyst system. The polymerization can be carried out, for example, in bulk phase using a liquid monomer (e.g., propylene) as a reaction medium, in slurry using an inert liquid (e.g., hydrocarbon) as a diluent, in solution using either monomers or inert hydrocarbons as solvent for polymerization, or in gas phase, operating in one or more fluidized or mechanically agitated bed reactors. In other aspects, the polymerization reaction may take place using melt extrusion, in which heat produced during the extrusion step provides the energy needed for reactions between the bimodal components described herein for forming the co-polypropylene polymer compositions described herein.

Co-polypropylene polymer compositions disclosed herein may include one or more additives in one or more stages of a polymerization process and/or before or after polymerization. Suitable additives may include mechanical and rheological modifiers such as carbon nanomaterials including carbon nanotubes, graphene, fullerenes, diamond-like carbon, or carbon black, fibers, nanocrystalline cellulose, cellulose nanofibrils, silica, silica-alumina, alumina such as (pseudo) bochmite, gibbsite, titania, zirconia, cationic clays or anionic clays such as saponite, bentonite, kaoline, sepiolite, hydrotalcite, and the like. Additives may also include metal oxides such as alumina trihydrate (ATH), aluminum monohydrate, magnesium hydroxide, magnesium silicate, talc, silicas such as fumed silica and precipitated silica, and calcium carbonate, calcium metasilicate, Wollastonite, Dolomite, Perlite, hollow glass spheres, kaolin, and the like.

Other additives may include fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); nucleators (e.g., aromatic carboxylic-acid salts, organic derivatives of dibenzylidene sorbitol, organophosphate salts, inorganic material lacking polymeric solubility); anti-cling additives; tackifiers, such as polybutenes, terpene resins, aliphatic and aromatic hydrocarbon resins, alkali metal and glycerol stearates, and hydrogenated rosins; UV stabilizers such as titanium oxide, zinc oxide, benzophenones, benzotriazoles, aryl esters, sterically hindered amines, the like; heat stabilizers; anti-blocking agents; release agents; anti-static agents; pigments; colorants; dyes; waxes; silica; fillers; tale; and the like.

In various aspects of the present disclosure, one or more polypropylene polymers having low ethylene content may be compounded (e.g., in an extruder) together and may be further compounded with one or more polypropylene polymers that lack ethylene content entirely (a polypropylene homopolymer).

### Example Embodiments

Nonlimiting example embodiments of the present disclosure include:

Embodiment A: A composition comprising: a bimodal molecular weight ethylene/propylene random copolymer comprising a high molecular weight component having a melt flow rate at 230° C. of from about 0.02 g/10 min to about 0.5 g/10 min and a low molecular weight component having a melt flow rate at 230° C. of from about 1 g/10 min to about 10 g/10 min, and an ethylene content of from about 0.40 wt. % to about 0.60 wt. %.

Embodiment B: A method comprising: polymerizing ethylene and propylene monomers to produce a bimodal molecular weight ethylene/propylene random copolymer comprising a high molecular weight component have a melt flow rate at 230° C. of from about 0.02 g/10 min to about 0.5 g/10 min and a low molecular weight component having a melt flow rate at 230° C. of from about 1 g/10 min to about 10 g/10 min, and an ethylene content of from about 0.40 wt. % to about 0.60 wt. %.

Embodiment C: A molded article comprising a bimodal molecular weight ethylene/propylene random copolymer comprising a high molecular weight component having a melt flow rate at 230° C. of from about 0.02 g/10 min to about 0.5 g/10 min and a low molecular weight component having a melt flow rate at 230° C. of from about 1 g/10 min to about 10 g/10 min, and an ethylene content of from about 0.40 wt. % to about 0.60 wt. %.

Nonlimiting example embodiments A, B, or C may include one or more of the following elements:

Element 1: wherein the composition has a flexural modulus of from about 240 kpsi to about 280 kpsi.

Element 2: wherein the composition has a tensile strength of from about 5200 psi to about 5700 psi.

Element 3: wherein the composition has a plaque haze value of from about 20% to about 35% based on a 1 mm thickness sample.

Element 4: wherein the composition has a molecular weight of from about 300 kg/mol to about 700 kg/mol.

Element 5: wherein the composition has a melt temperature of from about 150° C. to about 170° C.

Element 6: wherein the composition has a crystallinity temperature of from about 100°° C. to about 130° C.

Element 7: wherein the composition has a molecular weight distribution of from about 5 to about 20.

Element 8: wherein the composition has a Notched Izod impact value at 23° C. of from about 0.5 ft-lb/inch to about 1 ft-lb/inch.

Each of Embodiments A, B, and C may include any one, more, or all of Elements

1-8 in any combination.

Embodiment C may further include:

Element 9: wherein the molded article is a packaging product.

Embodiment C may have any one, more, or all of Elements 1-9 in any combination.

To facilitate a better understanding of the aspects of the present disclosure, the following examples of preferred or representative aspects are given. In no way should the following examples be read to limit, or to define, the scope of the disclosure.

### EXAMPLES

In the following examples, various experiments were performed and measurements taken to evaluate and validate the improvement in strength and toughness, as well as clarity, of the co-polypropylene polymer compositions described herein having a bimodal molecular weight distribution and low ethylene content.

Samples EX1-EX4 were prepared using a combination of one or more of polymer “granules”—G1, G2, and/or G3. G1 and G2 are co-polypropylene random polymers having a low ethylene content and G3 is a HMW polypropylene homopolymer. G1 and G2 further have a relatively lower molecular weight compared to G3. The melt flow rate and ethylene content of each of G1-G3 are provided in Table 1 below.

TABLE 1

| | Melt Flow Rate | Ethylene |
|---|---|---|
| | (g/10 min) | (%) |
| G1 | 2.93 | 0.49 |
| G2 | 2.78 | 0.42 |
| G3 | 0.36 | 0.00 |

G1 and G2 were compounded with an amount of G3 using a 30 mm Werner & Pfleiderer (Dinkelsbuhl, Germany) twin screw extruder, as provided in Table 2, with a nucleator masterbatch and antioxidant masterbatch, to form samples EX1-EX4. The nucleator masterbatch consists of an a-nucleator for polypropylene and the antioxidant masterbatch consists of both a phenolic-based primary antioxidant and a phosphate-based secondary antioxidant.

TABLE 2

| | | | | | Nucleator | Antioxidant |
|---|---|---|---|---|---|---|
| | | | | | Masterbatch | Masterbatch |
| | Granule | Wt. % | Granule | Wt. % | (ppm) | (ppm) |
| EX1 | G1 | 95 | G3 | 5 | 2855 | 3975 |
| EX2 | G1 | 90 | G3 | 10 | 2855 | 3975 |
| EX3 | G2 | 95 | G3 | 5 | 2855 | 3975 |
| EX4 | G2 | 90 | G3 | 10 | 2855 | 3975 |

Each of EX1-EX4 were tested for the qualities provided in Table 3 below, and according to the methods described herein. Each of EX1-EX4 was compared commercially available U.S. Plant Pat. No. 6,272NE1, a nucleated polypropylene homopolymer (ExxonMobil™, Texas), labeled as “CT” in Table 3. “TDS” stands for Technical Data Sheet, from which the value was 10 obtained.

TABLE 3

| | EX1 | EX2 | EX3 | EX4 | CT |
|---|---|---|---|---|---|
| MFR | 2.27 | 1.91 | 2.00 | 1.71 | 2.60 |
| (g/10 min) | | | | | |
| Tm | 160.4 | 16.9 | 162.4 | 162.8 | 160.0 |
| (° C.) | | | | | |
| Tc | 123.5 | 123.7 | 125.2 | 125.3 | 123.8 |
| (° C.) | | | | | |
| 1 mm | 26.8 | 25.9 | 25.5 | 27.6 | 28.7 |
| Plaque | | | | | |
| Haze | | | | | |
| (%) | | | | | |
| Flexural | 253.0 ± 1.5 | 251.0 ± 4.2 | 269.0 ± 7.0 | 275.0 ± 3.7 | 247 (TDS) |
| Modulus | | | | | |
| (kpsi) | | | | | |
| Tensile | 5322.1 ± 7.6 | 5331.6 ± 2.4 | 5633.5 ± 6.6 | 5638.9 ± 7.5 | 5390 |
| Strength | | | | | |
| (psi) | | | | | |
| Notched | 0.84 ± 0.05 | 0.88 ± 0.07 | 0.77 ± 0.02 | 0.78 ± 0.04 | 1.2 (TDS) |
| Izod | | | | | |
| (ft-lbs/inch) | | | | | |
| Mw | 423.3 | 469.4 | 556.2 | 592.0 | 406.1 |
| (kg/mol) | | | | | |
| MWD | 5.67 | 5.79 | 12.88 | 13.67 | 8.68 |

As shown in Table 3, as MWD is increased, so too is the stiffness and clarity of the co-polypropylene polymer. In each of EX1-EX4, the clarity remained comparable to the CT sample. Accordingly, the co-polypropylene polymer compositions of the present disclosure exhibit increased strength and toughness (stiffness) and clarity at low ethylene levels with bimodal MWDs. Such co-polypropylene polymer compositions may be particularly useful in thermoforming, low molding, and injection molding applications, such as for use in packaging products.

As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is:

1. A composition comprising:
a bimodal molecular weight ethylene/propylene random copolymer comprising a high molecular weight component having a melt flow rate at 230° C. of from about 0.02 g/10 min to about 0.5 g/10 min and a low molecular weight component having a melt flow rate at 230° C. of from about 1 g/10 min to about 10 g/10 min, and an ethylene content of from about 0.40 wt. % to about 0.60 wt. %.

2. The composition of claim 1, wherein the composition has a flexural modulus of from about 240 kpsi to about 280 kpsi.

3. The composition of claim 1, wherein the composition has a tensile strength of from about 5200 psi to about 5700 psi.

4. The composition of claim 1, wherein the composition has a plaque haze value of from about 20% to about 35% based on a 1 mm thickness sample.

5. The composition of claim 1, wherein the composition has a molecular weight of from about 300 kg/mol to about 700 kg/mol.

6. The composition of claim 1, wherein the composition has a melt temperature of from about 150° C. to about 170° C.

7. The composition of claim 1, wherein the composition has a crystallinity temperature of from about 100° C. to about 130° C.

8. The composition of claim 1, wherein the composition has a molecular weight distribution of from about 5 to about 20.

9. The composition of claim 1, wherein the composition has a Notched Izod impact value at 23° C. of from about 0.5 ft-lb/inch to about 1 ft-lb/inch.

10. A method comprising:
polymerizing ethylene and propylene monomers to produce a bimodal molecular weight ethylene/propylene random copolymer comprising a high molecular weight component have a melt flow rate at 230° C. of from about 0.02 g/10 min to about 0.5 g/10 min and a low molecular weight component having a melt flow rate at 230° C. of from about 1 g/10 min to about 10 g/10 min, and an ethylene content of from about 0.40 wt. % to about 0.60 wt. %.

11. The method of claim 10, wherein the bimodal molecular weight ethylene/propylene random copolymer has a flexural modulus of from about 240 kpsi to about 280 kpsi.

12. The method of claim 10, wherein the bimodal molecular weight ethylene/propylene random copolymer has a tensile strength of from about 5200 psi to about 5700 psi.

13. The method of claim 10, wherein the bimodal molecular weight ethylene/propylene random copolymer has a plaque haze value of from about 20% to about 35% based on a 1 mm thickness sample.

14. The method of claim 10, wherein the bimodal molecular weight ethylene/propylene random copolymer has a melt temperature of from about 150° C. to about 170° C.

15. The method of claim 10, wherein the bimodal molecular weight ethylene/propylene random copolymer has a crystallinity temperature of from about 100° C. to about 130° C.

16. The method of claim 10, wherein the bimodal molecular weight ethylene/propylene random copolymer has molecular weight of from about 300 kg/mol to about 700 kg/mol.

17. The method of claim 10, wherein the bimodal molecular weight ethylene/propylene random copolymer the composition has a molecular weight distribution of from about 5 to about 20.

18. The method of claim 10, wherein the bimodal molecular weight ethylene/propylene random copolymer has a Notched Izod impact value at 23° C. of from about 0.5 ft-lb/inch to about 1 ft-lb/inch.

19. A molded article comprising a bimodal molecular weight ethylene/propylene random copolymer comprising a high molecular weight component having a melt flow rate at 230° C. of from about 0.02 g/10 min to about 0.5 g/10 min and a low molecular weight component having a melt flow rate at 230° C. of from about 1 g/10 min to about 10 g/10 min, and an ethylene content of from about 0.40 wt. % to about 0.60 wt. %.

20. The molded article of claim 19, wherein the molded article is a packaging product.
